(19) United States
(12) Patent Application Publication
(10) Pub. No.: US 2026/0268604 A1
(43) Pub. Date: Sep. 10, 2026

(54) THREE DIMENSIONAL MESH OPTIMIZATION

(71) Applicant: QUALCOMM Incorporated, San Diego, CA (US)

(72) Inventors: Srikanth THATIPAMULA, Telangana (IN); Ajay SURENDRANATH, Bengaluru (IN)

(21) Appl. No.: 19/074,086

(22) Filed: Mar. 7, 2025

(51) Int. Cl. G06T 17/20; G06T 7/11; G06T 7/246; G06T 19/20

(52) U.S. Cl. CPC G06T 17/205; G06T 7/11; G06T 7/248; G06T 19/20; G06T 2219/2016

(57) ABSTRACT

Systems and techniques are described herein for mesh representation adjustment. For example, a computing device can process a first mesh representation of an environment to partition the environment into regions; determine landmarks of the regions based on movement of a user through the regions of the environment; and process the first mesh representation and a dynamic mesh representation to generate a blended mesh representation of the environment wherein the dynamic mesh representation has a different resolution than the first mesh representation including a higher resolution associated with the landmarks in the environment.

Aspects of the present disclosure generally relate three dimensional (3D) meshes of an environment. For example, aspects of the present disclosure relate to systems and techniques for 3D mesh optimization to provide 3D mesh representations of an environment.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can be included in a head-mounted device (HMD). HMDs can include a display allowing a user to view a real-world environment through the display. For example, the HMD can include a scene-facing camera to generate images of the real-world environment. XR technologies can use mesh generation techniques to generate three-dimensional representations of the environment, which can be rendered by the HMD to be displayed to a user.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for mesh representation adjustment is provided. The apparatus includes at least one memory and at least one processor coupled to the at least one memory and configured to: process a first mesh representation of an environment to partition the environment into regions; determine landmarks of the regions based on movement of a user through the regions of the environment; and process the first mesh representation and a dynamic mesh representation to generate a blended mesh representation of the environment wherein the dynamic mesh representation has a different resolution than the first mesh representation including a higher resolution associated with the landmarks in the environment.

In some aspects, a method for mesh representation adjustment is provided. The method includes: processing a first mesh representation of an environment to partition the environment into regions; determining landmarks of the regions based on movement of a user through the regions of the environment; and processing the first mesh representation and a dynamic mesh representation to generate a blended mesh representation of the environment wherein the dynamic mesh representation has a different resolution than the first mesh representation including a higher resolution associated with the landmarks in the environment.

In some aspects, a non-transitory computer-readable medium is provided having stored thereon instructions that, when executed by at least one processor, cause the at least one processor to: process a first mesh representation of an environment to partition the environment into regions; determine landmarks of the regions based on movement of a user through the regions of the environment; and process the first mesh representation and a dynamic mesh representation to generate a blended mesh representation of the environment wherein the dynamic mesh representation has a different resolution than the first mesh representation including a higher resolution associated with the landmarks in the environment.

In some aspects, an apparatus for wireless communication is provided. The apparatus includes: means for processing a first mesh representation of an environment to partition the environment into regions; means for determining landmarks of the regions based on movement of a user through the regions of the environment; and means for processing the first mesh representation and a dynamic mesh representation to generate a blended mesh representation of the environment wherein the dynamic mesh representation has a different resolution than the first mesh representation including a higher resolution associated with the landmarks in the environment.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an architecture of an example extended reality (XR) system, in accordance with aspects of the disclosure;

FIG. 2 is a block diagram illustrating an example system for 3D scene optimization., in accordance with aspects of the disclosure;

FIG. 3 is a block diagram illustrating example mesh representations of an environment provided to applications of a client device, in accordance with aspects of the disclosure;

FIG. 4 is a block illustrating an example technique of determining landmarks represented in a mesh, in accordance with aspects of the disclosure;

FIG. 5 is a block diagram illustrating example data structures mapping insights of the mesh with regions or polygons of the mesh, in accordance with aspects of the disclosure;

FIG. 6 is a flow diagram illustrating an example of process for mesh representation adjustment, in accordance with some examples; and

FIG. 7 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can be included in a head-mounted device (HMD). HMDs can include a display allowing a user to view a real-world environment through the display. For example, the HMD can include a scene-facing camera to generate images of the real-world environment. XR technologies can use mesh generation techniques to generate three-dimensional representations of the environment, which can be rendered by the HMD to be displayed to a user.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. For example, AR content can include adding a heads-up display (HUD) providing informational virtual content to users regarding their environment. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment (e.g., an AR environment, VR environment, and/or MR environment) can be interacted with in a seemingly real or physical way. For example, as a user experiencing an AR environment (e.g., an augmented version of a real-world environment) moves in the real world, rendered virtual content (e.g., images rendered in a virtual environment during an AR experience) also changes, giving the user the perception that the user is moving within the AR environment. For example, a user can turn left or right, look up or down, and/or move forwards or backwards, thus changing the user's point of view of the AR environment. The AR content presented to the user can change accordingly, so that the user's experience in the AR environment is as seamless as it would be in the real world. Similar experiences can be presented in VR and/or MR environments.

In some examples, the XR device can include one or more optical sensors (e.g., cameras). In such an example, the XR device can include one or more scene-facing optical sensors and ranging sensors (e.g., multiple cameras, light detection and ranging (LIDAR) sensors, etc.) and eye-facing camera. In some examples, the XR device can generate visual representations of the environment from the scene-facing optical sensors and a user view of the visual representation based on the eye-facing camera. In one example, a display of an optical see-through XR device can include a lens or glass in front of each eye (or a single lens or glass over both eyes). The see-through display can allow the user to see a real-world or physical object directly, and can display (e.g., projected or otherwise displayed) an enhanced image of that object or additional AR content (e.g., virtual content overlaid on a visual representation of the environment) to augment the user's visual perception of the real world.

In some cases, an XR system can match the relative pose and movement of objects and devices in the physical world. For example, the XR system can use tracking information to calculate the relative pose of devices, persons, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with virtual objects and a mesh representation of the real-world environment.

XR systems or devices can facilitate interaction with different types of XR environments (e.g., a user can use an XR system or device to interact with an XR environment). One example of an XR environment is a virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

Meshes can include graphical representations of a 3D space (e.g., a 3D geometrical representation of a real-world or virtual environment), generally represented as a plurality of vertices, edges, and faces of polygons. In some examples, meshes can represent geometric approximations of the topology of an environment by processing the representations of the environment into a plurality of polygons. Meshes (also referred to as mesh representations) can vary in resolution. For example, the mesh resolution (e.g., level of detail of the mesh) can be represented by the number of vertices, edges, and faces of polygons used in the mesh to represent the environment and objects in the environment. In such an example, a higher resolution mesh can include a higher polygon count (e.g., more vertices, edges, and faces of polygons) as compared to a lower resolution mesh. In some examples, meshes can be represented as a 3D point cloud of an environment. For example, the 3D point cloud can be a plurality of data points within the environment including spatial data representing locations of objects with x, y, and z coordinates. In some examples, the 3D point cloud can include additional information such as color, intensity, texture, and other information associated with objects or the environment at x, y, and z coordinates.

In some examples, meshes can be represented graphically or as a data structure. For example, a graphical representation of meshes can be a 3D geometrical rendering of the environment viewable by a user through a display, such as a phone screen, or display of an HMD. In another example, the data structure can include information associated with various polygons of the mesh. For example, the data structure can include mesh insight information such as lighting information, landmark information, texture information, labels, etc. For example, each polygon (or grouping of polygons) can include a plurality of parameters associated with the polygon, such as lighting information, landmark information, texture information, labels, etc.

In some examples, XR devices (e.g., an XR HMD) and other devices such as a smartphone, camera, tablet, etc. can use scene-facing cameras to generate images of an environment. In further examples, the XR devices can include ranging sensors, such as light detection and ranging (LIDAR), stereo cameras, or can use various image processing techniques to generate the meshes. In further examples, generation of meshes can be performed on another device, service, or application using the captured images and ranging data of the environment.

Mesh representations of an environment can be used by various applications and services to augment user perception of the environment, such as by overlaying graphics on the environments, adding virtual objects within the environment, simulating immersive audio (e.g., simulating audio reverberations through the mesh representation of the environment, adding sounds from virtual objects to provide spatial understanding of the environment), etc. In further examples, various applications and services can use mesh representations of an environment can allow users to virtually navigate a 3D representation of the environment, such as allowing a user to tour a home, a museum, or other location without being physically present in the environment.

The various applications and services using mesh representations can have different resolution requirements to perform various operations. For example, an application for simulating audio within an environment (e.g., within the environment represented in the 3D mesh) can use a lower resolution mesh representation than another application or service, such as an application or service rendering the mesh for viewing of the user. In such an example, a higher resolution mesh representation can be used when rendering a viewable mesh representation, for example because a user can be more likely to identify visible occlusions or incorrect geometric representations of an environment than to identify incorrect geometric representations from simulated audio reverberations through the mesh representation.

In some examples, multiple services or applications can run concurrently to provide a user experience. For example, in a service rendering a viewable mesh representation can run concurrently with a service simulating acoustics of the environment from the mesh representation to provide a user experience simulating user presence within the environment of the mesh representation. In such an example, latency of the services can impact usability of the services.

In further examples, different regions of an environment can use different resolution meshes. For example, an object represented in the mesh representation which at greater distances can have use lower resolution mesh representations to conserve computing resources in scenarios where a user would be unable to perceive a difference in resolution. For example, a first object closer to the user can be represented in the mesh with a higher resolution (e.g., higher number of polygons) than a second object further away from the user. In further examples, different surfaces of the environment can be represented with different resolutions and level of detail. For example, a ceiling can be represented with a different resolution than a wall or object, etc.

In another example, higher resolution meshes can be used within a field of view of the user. The field of view can be a frustum view (e.g., a conical view indicating a predicted boundary of the vision of the users). In such an example, the mesh representation can include a higher level of detail (e.g., higher resolution with a higher number of polygons) in portions of the mesh representation within the field of view of the user. Optimization of the level of detail (e.g., resolution) of rendered mesh representations can reduce the amount of computational power to render the mesh representations and can reduce latency of services and applications by reducing the amount of data and information transmitted (e.g., transmitted to various applications and services) and rendered.

Systems, apparatuses, electronic devices, methods (also referred to as processes), and computer-readable media (collectively referred to herein as “systems and techniques”) are described herein for a 3D scene optimization engine for processing, adjusting, and transmitting meshes (also referred to as mesh representations of an environment) for use in applications or services. For example, different applications and services may use mesh representations of different levels of details (or resolutions). The 3D scene optimization engine can process mesh representations based on mesh parameters (also referred to as policies) of applications and services using the mesh representations.

In such an example, a first application, such as a real estate application for touring homes, may use a mesh representation having a higher level of detail than an application for simulating audio reverberation within the environment represented in the mesh representation. In some examples, the applications and services can be executed on a separate device or apparatus from the 3D scene optimization engine. For example, the 3D scene optimization engine can be executed on a server. The applications and services can be performed on another server or client device. In such an example, the applications and services can request mesh representations with various mesh parameters (e.g., resolution and level of detail, portions of meshes based on user location, etc.) from the 3D scene optimization engine. The 3D scene optimization engine can provide a mesh representation to the applications and services based on the mesh parameters.

In some aspects, the systems and techniques can include receiving a plurality of meshes from a mesh generator. In such an example, the mesh generator can be an image processing engine to generate a mesh from images and ranging sensor data (e.g., LIDAR sensor data). In some examples, the mesh generator can be executed on an XR HMD. In such an example, the XR HMD can have a scene-facing camera to generate images of a real-world environment. In further examples, the XR HMD can use ranging sensors to determine distances of objects within the real-world environment to provide spatial data used to generate meshes.

The mesh generator can generate meshes at various resolutions (e.g., various levels of detail such as a high resolution, medium resolution, and low resolution mesh). For example, the meshes can be polygonal representations (or approximations) of the environment. A higher resolution or higher level of detail mesh can use more polygons (e.g., more vertices, edges, and faces of polygons) to provide a more accurate representation of the environment. In some examples, the polygons can be of substantially the same shape and size. In some examples, the polygons can be triangles of substantially the same size. In further examples, the mesh can include polygons of various shapes and sizes based on an object in the environment (e.g., the polygons used to represent a wall may differ in shape and size from the polygons used to represent a ball, etc.).

The mesh generator can use various 3D modeling techniques to generate meshes of varying levels of detail. For example, the mesh generator can use techniques such as tessellation to determine surfaces of an environment as a construction of geometric shapes, such as triangles, quadrilaterals, or other polygons. Other techniques can include voxel construction to generate 3D representations of the environment.

In some aspects, the mesh generator can track information associated with the environment and user interaction with the environment. For example, the mesh generator can perform light estimation of the environment. In such an example, the mesh generator can determine a light intensity associated with planes of the mesh or polygons of the mesh. In further examples, the mesh generator can determine user head pose and location within the environment. In another example, the mesh generator can track eye movements of the user. In such an example, the mesh generator can receive information from an HMD with eye-tracking cameras. The mesh generator can determine, based on gaze direction (represented as a gaze vector) of the user, where the user is looking.

In one example, the HMD can determine where the user is looking based on a fovea region (e.g., the fovea being a point within the retina) of the eye of the user. In some examples, the mesh generator can determine where the user is looking based on pose of the user head such as the pose of the HMD worn by the user. The mesh generator can provide a gaze vector associated with where the user is looking and the field of view of the user to the 3D scene optimization engine.

The mesh generator can provide the generated meshes and information associated with the user and the environment (e.g., user location, user movement, gaze direction, light intensity, etc.) to the 3D scene optimization engine. In some examples, the mesh generator can automatically provide updated meshes and information associated with the user and the environment based on changes in the environment or movement of the user. For example, an object may be moved in the environment, such as moving a chair in a room. In such an example, the mesh generator can generate updated meshes of various resolutions and provide the updated meshes to the 3D scene optimization engine.

The 3D scene optimization engine can process meshes to determine insights of the meshes. Insights of the meshes include determined relationships of the characteristics of the meshes (e.g., partitioning of regions of an environment represented in the mesh, determining landmarks represented in the mesh, lighting of the environment represented in the mesh, etc.). For example, the insights can include determinations of different regions of the environment represented in the mesh. For example, the mesh can be a mesh representation of a house. In such an example, the insights can include partitioning the house into different regions based on rooms (e.g., a kitchen being a first region, a bedroom being a second region, etc.). The insights can be applied as labels to a data structure mapping insights to various polygons of the mesh, or plurality of polygons, to provide context to the polygons of the mesh.

For example, the 3D scene optimization engine can process meshes and determine based on the structure and clustering of the polygons of the mesh, perimeters of the environment represented in the mesh. The 3D scene optimization engine can partition the mesh into regions based on how the polygons of the mesh connect. For example, the 3D scene optimization engine can determine, based on the connection of the polygons of a mesh, the presence of a wall in the environment represented in the mesh. The 3D scene optimization engine can determine the portion of the mesh including the wall is a separate region of the mesh (such as a separate room) based on detected walls. The 3D scene optimization engine can generate a tag or label associated with the region of the mesh and apply the tag or label to a data structure mapping the tags or labels to the polygons within the region. For example, the data structure can be key-value pairs mapping polygons, plurality of polygons, etc. to insights of the mesh such as the region, landmarks, locations, etc.

In some examples, the 3D scene optimization engine can process meshes and information associated with the user and environment to determine insights of meshes such as the presence of landmarks represented in the meshes. Landmarks can include objects or locations represented in the mesh which are determined as likely or regularly to be viewed or accessed by users. For example, the 3D scene optimization engine can determine landmarks based on movement of users through the environment represented in the mesh. In such an example, the 3D scene can determine landmarks to be traversable locations connecting regions of the mesh such as doorways, hallways, windows, etc. For example, the 3D scene optimization engine can determine, based on user movement and the mesh, that a doorway connects a first region and a second region of the mesh. In such an example, the data structure mapping polygons to insights can include labels indicating which polygons are associated the landmark.

In another example, the 3D scene optimization engine can determine a location or object represented in the mesh is a landmark based on user interaction with the location or object. For example, the mesh can be a mesh representation of a house. The 3D scene optimization engine can determine based on user movement through the house, that a television is a landmark based on an amount of time the user spends looking at the television. In another example, the 3D scene optimization engine can determine that a chair is a landmark based on how often the user travels to the chair and the amount of time the user sits in the chair. In such an example, the 3D scene optimization engine can generate labels associated with the television and chair, and update a register associated with the polygons representing the television and chair to label the television and chair as landmarks.

In some aspects, the 3D scene optimization engine can predict user trajectory (e.g., where the user is likely traveling to) when the user moves through the environment. The user trajectory can be based on insights of the mesh, such as the landmarks and regions of the mesh. For example, the 3D scene optimization engine can predict user trajectory based on whether a user is moving towards a landmark. In such an example, the 3D scene optimization can predict a user trajectory that traverses the environment heading to the landmark (e.g., avoiding objects and heading through traversable connections between regions such as doorways).

In some examples, user movement is physical movement through the environment. For example, the user can use an HMD or other device to track user physical movement through a real-world environment. In other examples, the movement can be virtual. For example, when the user is moving through the virtual environment (e.g., moving through a visual rendering of the mesh). In one such example, the user can be on a virtual tour of a visual rendering of the mesh.

In another example, the 3D scene optimization engine can use lighting information (e.g., light intensity information from the mesh generator) to generate additional insights of meshes. For example, the 3D scene optimization engine can generate a light map score based on the light intensity information from the mesh generator. In such an example, the 3D scene optimization engine can periodically receive lighting information from the mesh generator. For example, the mesh generator can provide updated lighting information based on changes in lighting in an environment represented in the mesh. The 3D scene optimization engine can update light map scores (e.g., values representing light intensity, direction, angle, source location, etc.) based on the updated lighting information. In some examples, the light map score can be a data structure mapping light intensity, direction, angle, source location etc. of a plane of the mesh. In further examples, the light map score can be a data structure mapping light intensity, angle, direction, source location etc. to polygons of the mesh. In such an example, the light map scores associated with the polygons of the mesh can be applied as labels to polygons to represent insights (e.g., characteristics and relationships between polygons) of the mesh.

In some aspects, the 3D scene optimization engine can provide various information (e.g., lighting scores or a total light score) associated with lighting characteristics of the environment such as ambient light, directional light, high dynamic range (HDR) map, etc. For example, ambient light can include global illumination providing for a consistent light score across regions of the environment. Directional light can indicate shadow regions within the scene. In such an example, polygons associated with the shadow regions can be mapped to lower light scores. The light scores can be combined to determine a total light score for the polygons.

In some aspects, the 3D scene optimization engine can use user attention information (e.g., user location, head tracking, gaze tracking from the mesh generator) to generate attention scores. An attention score can be a value representing an amount of time or frequency of a user interacting with objects or locations represented in the mesh. In some examples, the attention score can be used to determine landmarks. For example, when the attention score exceeds a threshold, the objects or locations associated with the attention score can be labeled a landmark. In one example, the attention score is assigned to planes of the environment associated with a gaze vector of the user (e.g., a gaze vector from the mesh generator). In such an example, polygons associated with the plane can be assigned attention scores. For example, the 3D scene optimization engine can apply a label or annotation indicating attention score of polygons representing an amount of attention (e.g., in time or frequency) in which a user interacts (e.g., physical interaction or observing such as by looking at the polygons or plane) with the polygons.

In some aspects, the 3D scene optimization engine can generate a weighted score associated with the light map score and the attention scores. In such an example, the 3D scene optimization engine can generate a data structure to map the weighted scores to meshes of varying resolutions and levels of detail. In some aspects, the 3D scene optimization engine can use the weighted score to refine meshes. For example, the 3D scene optimization engine can use the weighted score to blend meshes of different resolutions. In some examples, the light map score, the attention scores, and the weighted score can be determined by the mesh generator. In such an example, the mesh generator can generate a data structure mapping the weighted scores to meshes of varying resolutions. In such an example, the mesh generator can provide the data structure to the 3D scene optimization engine to use to blend meshes.

In some aspects, the 3D scene optimization engine can blend mesh representations of the environment based on determined insights, mesh parameters of the applications and services to receive the blended mesh representations, and user movement in the environment (e.g., user location, user field of view, predicted user trajectory, etc.). For example, the 3D scene optimization engine can blend a lower resolution mesh representation for portions of the mesh representations that the user is not observing to conserve computing resources used by applications and services receiving the blended mesh representation. In such an example, the amount of data processed using the applications and services can be reduced by prioritizing higher levels of detail (e.g., higher resolution and virtual object rendering) of the portions of the meshes which users interact with or are predicted to interact thereby conserving computing resources.

For example, the 3D scene optimization engine can blend a first mesh of a first resolution with a second mesh of a second resolution to generate a blended mesh with different resolutions and levels of detail in different regions of the mesh. In some examples, the 3D scene optimization engine can generate a blended mesh with a higher resolution within a field of view of a user. In another example, the 3D scene optimization engine can generate a blended mesh with a higher resolution associated with landmarks represented in the mesh (e.g., the landmarks having a higher level of detail than other objects or locations represented in the mesh). In some examples, the second mesh can be a dynamic mesh representation. For example, the second mesh can be continuously or periodically adjusted. The adjustments to the second mesh can include adjustments to resolution of portions of the second mesh. In some examples, the second mesh can be adjusted based on a user location, lighting conditions, and a user viewpoint. In such an example, real-time adjustment can be used to ensure the scene represented in the second mesh is accurate and responsive to environmental changes.

In a further example, the 3D scene optimization engine can generate a blended mesh with a higher resolution associated with a predicted trajectory of the user. For example, the 3D scene optimization engine can determine, based on user movement and landmarks of the environment, a predicted trajectory of the user. In such an example, the 3D scene optimization engine can generate a blended mesh with higher resolutions along the predicted trajectory of the user. In such an example, the 3D scene optimization engine can pre-cache (e.g., store in memory) the blended mesh to be transmitted to the applications or services (e.g., the applications or services executed on a client device). By having the blended mesh representation pre-cached to be transmitted, the 3D scene optimization engine can reduce latency between the 3D scene optimization engine and the applications or services using the blended mesh.

In some aspects, the 3D scene optimization engine can generate blended meshes using the weighted scores (e.g., the data structure representing weighted scores of the attention score and the light map score). For example, the 3D scene optimization engine can apply the weighted scores to planes within the field of view of the user (e.g., within a frustum representing the field of view of the user). The 3D scene optimization engine can adjust the meshes based on the weighted score, such as by using higher resolution meshes for parts of the mesh associated with weighted scores indicating the user views the part of the environment associated with the mesh more often or for longer durations.

In some aspects, the 3D scene optimization engine can generate blended meshes based on mesh parameters (e.g., policies) of the applications and services to receives the blended meshes. For example, the applications and services can include an update frequency parameter and a quality parameter (e.g., resolution and level of detail parameter). In such an example, an application associated with AR gaming may use a higher resolution map than an application for virtually touring an environment. The respective applications can provide the quality parameter to the 3D scene optimization engine to use when determining which meshes to blend to comport with the quality parameter.

The update frequency parameter can represent how often or when the 3D scene optimization engine should transmit an updated mesh (e.g., updated blended mesh). For example, the update frequency parameter can be periodic (e.g., every preset period of time). In other examples, the update frequency parameter can be based on changes to the mesh and user movement. For example, the update frequency parameter can indicate the 3D scene optimization engine should transmit an updated mesh based on changes in lighting, user movement, changes in user field of view (e.g., movement of the frustum view associated with movements of the user), etc. The level of detail of the blended mesh can be dynamic based on the weighted score of planes in the field of view of the user. In some examples, multiple applications or services can concurrently request blended meshes of different levels of detail.

Various aspects of the systems and techniques described herein will be discussed below with respect to the figures.

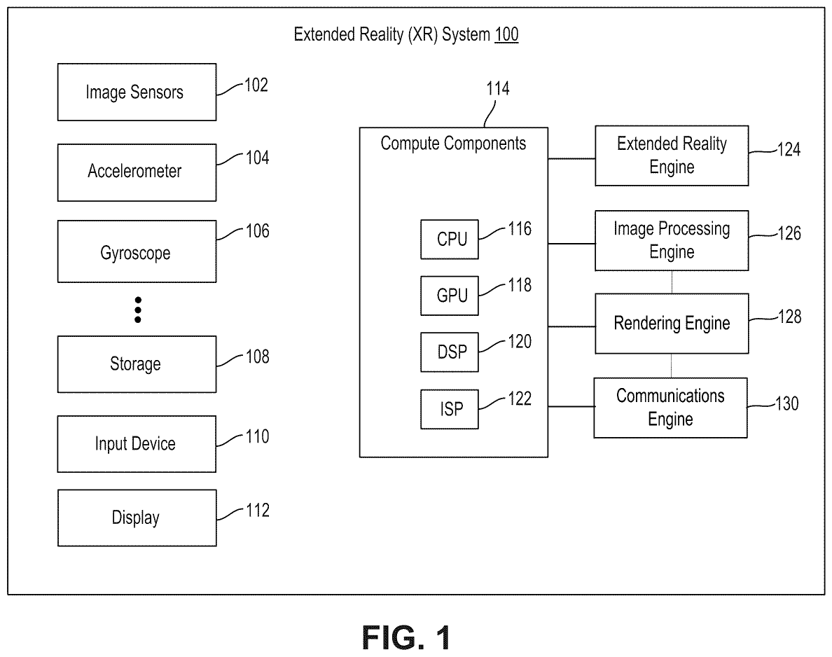

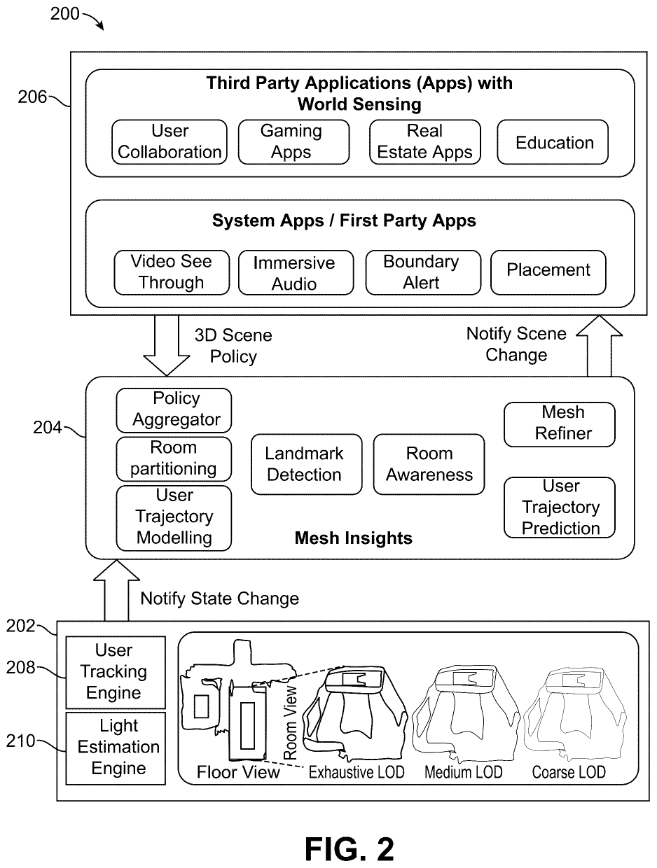

FIG. 1 is a diagram illustrating an architecture of an example extended reality (XR) system 100, in accordance with some aspects of the disclosure. XR system 100 may execute XR applications and implement XR operations. XR system 100 can include the HMD referenced in FIGS. 2-5. In some examples, the XR system can execute operations of the mesh generator 202 or the 3D scene optimization engine 204 of FIG. 2.

In this illustrative example, XR system 100 includes one or more image sensors 102, an accelerometer 104, a gyroscope 106, storage 108, an input device 110, a display 112, Compute components 114, an XR engine 126, an image processing engine 128, a rendering engine 130, and a communications engine 132. It should be noted that the components 102-132 shown in FIG. 1 are non-limiting examples provided for illustrative and explanation purposes, and other examples may include more, fewer, or different components than those shown in FIG. 1. For example, in some cases, XR system 100 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 1. While various components of XR system 100, such as image sensor 102, may be referenced in the singular form herein, it should be understood that XR system 100 may include multiple of any component discussed herein (e.g., multiple image sensors 102).

Display 112 can be, or can include, a glass, a screen, a lens, a projector, and/or other display mechanism that allows a user to see the real-world environment and also allows virtual content to be overlaid, overlapped, blended with, or otherwise displayed thereon.

XR system 100 can include, or can be in communication with, (wired or wirelessly) an input device 110. Input device 110 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 102 can capture images that may be processed for interpreting gesture commands.

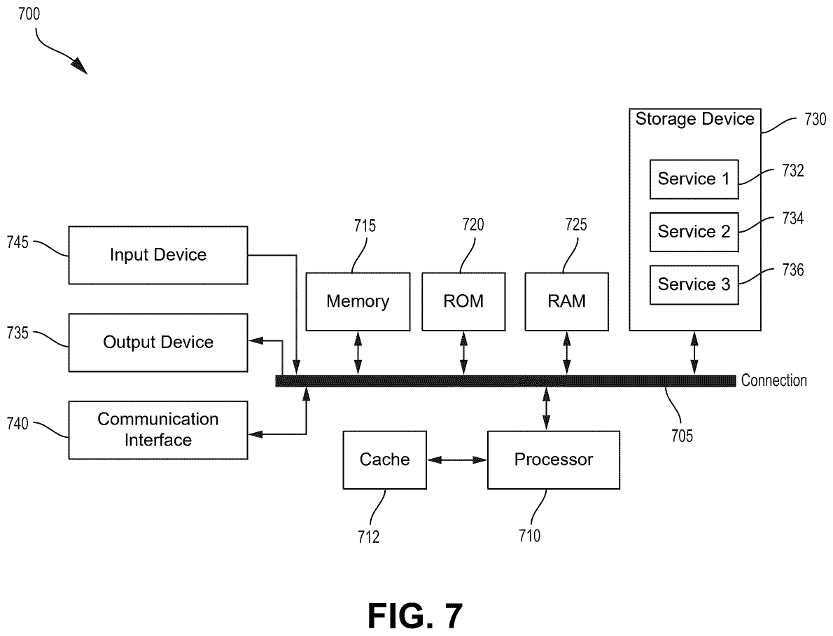

XR system 100 can also communicate with one or more other electronic devices (wired or wirelessly). For example, communications engine 132 can be configured to manage connections and communicate with one or more electronic devices. In some cases, communications engine 132 can correspond to communications interface 740 of FIG. 7.

In some implementations, image sensors 102, accelerometer 104, gyroscope 106, storage 108, display 112, compute components 114, XR engine 126, image processing engine 128, and rendering engine 130 can be part of the same computing device. For example, in some cases, image sensors 102, accelerometer 104, gyroscope 106, storage 108, display 112, compute components 114, XR engine 126, image processing engine 128, and rendering engine 130 may be integrated into an HMD, extended reality glasses, smartphone, laptop, tablet computer, gaming system, and/or any other computing device. However, in some implementations, image sensors 102, accelerometer 104, gyroscope 106, storage 108, display 112, compute components 114, XR engine 126, image processing engine 128, and rendering engine 130 may be part of two or more separate computing devices. For instance, in some cases, some of the components 102-132 may be part of, or implemented by, one computing device and the remaining components can be part of, or implemented by, one or more other computing devices. For example, such as in a split perception XR system, XR system 100 can include a first device (e.g., an HMD), including display 112, image sensor 102, accelerometer 104, gyroscope 106, and/or one or more compute components 114. XR system 100 may also include a second device including additional compute components 114 (e.g., implementing XR engine 126, image processing engine 128, rendering engine 130, and/or communications engine 132). In such an example, the second device may generate virtual content based on information or data (e.g., images, sensor data such as measurements from accelerometer 104 and gyroscope 106) and can provide the virtual content to the first device for display at the first device. The second device can be, or can include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 108 can be any storage device(s) for storing data. Moreover, storage 108 can store data from any of the components of XR system 100. For example, storage 108 may store data from image sensor 102 (e.g., image or video data), data from accelerometer 104 (e.g., measurements), data from gyroscope 106 (e.g., measurements), data from compute components 114 (e.g., processing parameters, preferences, virtual content, rendering content, scene maps, tracking and localization data, object detection data, privacy data, XR application data, face recognition data, occlusion data, etc.), data from XR engine 126, data from image processing engine 128, and/or data from rendering engine 130 (e.g., output frames). In some examples, storage 108 may include a buffer for storing frames for processing by compute components 114.

Compute components 114 can be or can include a central processing unit (CPU) 116, a graphics processing unit (GPU) 118, a digital signal processor (DSP) 120, an image signal processor (ISP) 122, a neural processing unit (NPU) 124, which may implement one or more trained neural networks, and/or other processors. Compute components 114 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 114 may implement (e.g., control, operate, etc.) XR engine 126, image processing engine 128, and rendering engine 130. In other examples, compute components 114 may also implement one or more other processing engines.

Image sensor 102 can include any image and/or video sensors or capturing devices. In some examples, image sensor 102 can be part of a multiple-camera assembly, such as a dual-camera assembly. Image sensor 102 can capture image and/or video content (e.g., raw image and/or video data), which can then be processed by compute components 114, XR engine 126, image processing engine 128, and/or rendering engine 130 as described herein.

In some examples, image sensor 102 can capture image data and can generate images (also referred to as frames) based on the image data and/or may provide the image data or frames to XR engine 126, image processing engine 128, and/or rendering engine 130 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 102 (and/or other camera of XR system 100) can be configured to also capture depth information. For example, in some implementations, image sensor 102 (and/or other camera) may include an RGB-depth (RGB-D) camera. In some cases, XR system 100 can include one or more depth sensors (not shown) that are separate from image sensor 102 (and/or other camera) and that may capture depth information. For instance, such a depth sensor may obtain depth information independently from image sensor 102. In some examples, a depth sensor may be physically installed in the same general location or position as image sensor 102 but may operate at a different frequency or frame rate from image sensor 102. In some examples, a depth sensor may take the form of a light source that may project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 100 can also include other sensors in its one or more sensors. The one or more sensors may include one or more accelerometers (e.g., accelerometer 104), one or more gyroscopes (e.g., gyroscope 106), and/or other sensors. The one or more sensors may provide velocity, orientation, and/or other position-related information to compute components 114. For example, accelerometer 104 may detect acceleration by XR system 100 and may generate acceleration measurements based on the detected acceleration. In some cases, accelerometer 104 may provide one or more translational vectors (e.g., up/down, left/right, forward/back) that may be used for determining a position or pose of XR system 100. Gyroscope 106 can detect and measure the orientation and angular velocity of XR system 100. For example, gyroscope 106 may be used to measure the pitch, roll, and yaw of XR system 100. In some cases, gyroscope 106 may provide one or more rotational vectors (e.g., pitch, yaw, roll). In some examples, image sensor 102 and/or XR engine 126 may use measurements obtained by accelerometer 104 (e.g., one or more translational vectors) and/or gyroscope 106 (e.g., one or more rotational vectors) to calculate the pose of XR system 100. As previously noted, in other examples, XR system 100 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of XR system 100, using a combination of one or more accelerometers, one or more gyroscopes, and/or one or more magnetometers. In some examples, the one or more sensors may output measured information associated with the capture of an image captured by image sensor 102 (and/or other camera of XR system 100) and/or depth information obtained using one or more depth sensors of XR system 100.

The output of one or more sensors (e.g., accelerometer 104, gyroscope 106, one or more IMUs, and/or other sensors) can be used by XR engine 126 to determine a pose of XR system 100 (also referred to as the head pose) and/or the pose of image sensor 102 (or other camera of XR system 100). In some cases, the pose of XR system 100 and the pose of image sensor 102 (or other camera) can be the same. The pose of image sensor 102 refers to the position and orientation of image sensor 102 relative to a frame of reference (e.g., field of view of the camera). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g. roll, pitch, and yaw).

In some cases, a device tracker (not shown) can use the measurements from the one or more sensors and image data from image sensor 102 to track a pose (e.g., a 6DoF pose) of XR system 100. For example, the device tracker can fuse visual data (e.g., using a visual tracking solution) from the image data with inertial data from the measurements to determine a position and motion of XR system 100 relative to the physical world (e.g., the scene) and a map of the physical world. As described below, in some examples, when tracking the pose of XR system 100, the device tracker can generate a three-dimensional (3D) map of the scene (e.g., the real world) and/or generate updates for a 3D map of the scene. For example, the 3D map can be a mesh representation of the real-world. The 3D map updates can include, for example and without limitation, new or updated features and/or feature or landmark points associated with the scene and/or the 3D map of the scene, localization updates identifying or updating a position of XR system 100 within the scene and the 3D map of the scene, etc. The 3D map can provide a digital representation of a scene in the real/physical world (e.g., the 3D map can be a mesh representation the real/physical world). In some examples, the 3D map can anchor position-based objects and/or content to real-world coordinates and/or objects. XR system 100 can use a mapped scene (e.g., a scene in the physical world represented by, and/or associated with, a 3D map) to merge the physical and virtual worlds and/or merge virtual content or objects with the physical environment.

In some aspects, the pose of image sensor 102 and/or XR system 100 as a whole can be determined and/or tracked by compute components 114 using a visual tracking solution based on images captured by image sensor 102 (and/or other camera of XR system 100). For instance, in some examples, compute components 114 can perform tracking using computer vision-based tracking, model-based tracking, and/or simultaneous localization and mapping (SLAM) techniques. For instance, compute components 114 can perform SLAM or can be in communication (wired or wireless) with a SLAM system (not shown). SLAM refers to a class of techniques where a map of an environment (e.g., a map of an environment being modeled by XR system 100) is created while simultaneously tracking the pose of a camera (e.g., image sensor 102) and/or XR system 100 relative to that map. The map can be referred to as a SLAM map and can be three-dimensional (3D). The SLAM techniques can be performed using color or grayscale image data captured by image sensor 102 (and/or other camera of XR system 100), and can be used to generate estimates of 6DoF pose measurements of image sensor 102 and/or XR system 100. Such a SLAM technique configured to perform 6DoF tracking can be referred to as 6DoF SLAM. In some cases, the output of the one or more sensors (e.g., accelerometer 104, gyroscope 106, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 102 (and/or other camera) to the SLAM map. For example, 6DoF SLAM can use feature point associations from an input image to determine the pose (position and orientation) of the image sensor 102 and/or XR system 100 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 102 and/or the XR system 100 can be determined by projecting features from the 3D SLAM map into an image or video frame and updating the camera pose from verified 2D-3D correspondences.

In one illustrative example, the compute components 114 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 114 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 100 can also track the hand and/or fingers of the user to allow the user to interact with and/or control virtual content in a virtual environment. For example, the XR system 100 can track a pose, gestures, and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

FIG. 2 is a block diagram illustrating an example system 200 for 3D scene optimization. The system 200 includes a mesh generator 202, a 3D scene optimization engine 204, and client devices 206. In some examples, the 3D scene optimization engine 204 can be a cloud service or application operating on an edge device, cloud service provider infrastructure, server, etc. In such an example, the client devices 206 can include various computing devices configured to communicate with the 3D scene optimization engine 204 (or the hardware executing the 3D scene optimization engine 204). For example, the client devices can include smartphones, HMDs, tablets, laptops, etc.

The mesh generator 202 can be an application or program operating on a computing device, such as a smartphone, HMD, tablet, laptop, etc. The mesh generator 202 can use various 3D modeling techniques to generate mesh representations of a real-world environment. For example, the mesh generator can use techniques such as tessellation to determine surfaces of an environment as a construction of geometric shapes (e.g., triangles, quadrilaterals, or other polygons).

In some examples, the mesh generator 202 can receive data associated with the environment from various sensors, devices, and data sources. For example, the mesh generator 202 can be executed on an HMD, such as the XR system 100 of FIG. 1. For example, the HMD can include various cameras to generate images of the environment. In some examples, the HMD can include ranging sensors such as LIDAR sensors to generate spatial data representing depth and distances of the environment (e.g., how far objects are, distances of walls, etc.).

The mesh generator 202 can generate meshes at various resolutions (e.g., various levels of detail). For example, the mesh generator 202 can generate an exhaustive mesh (e.g., a high resolution mesh), a coarse mesh (e.g., a low resolution mesh), and a medium mesh (e.g., a mesh with resolution and level of detail between the exhaustive mesh and the coarse mesh). The the meshes can be polygonal representations of the environment. A higher resolution or higher level of detail mesh can use more polygons (e.g., more vertices, edges, and faces of polygons) to provide a more accurate representation of the environment.

In some examples, the mesh generator 202 can include a user tracking engine 208 and a light estimation engine 210. The user tracking engine 208 can receive user movement data from the HMD associated with user position and movement within the environment of which the mesh generator 202 is to generate a mesh. For example, the user movement data can include head pose of the user, eye tracking movements captured by an eye-tracking camera, paths taken by the user when moving through the environment, etc. In one example, the mesh generator 202 can determine where the user is looking based on pose (e.g., orientation) an HMD worn by the user. The user movement data can include a gaze vector associated with where the user is looking and the field of view of the user to the 3D scene optimization engine 204.

In some examples, the light estimation engine 210 can perform light estimation of the environment. For example, the data collected by the HMD (or other device collecting data associated with the environment used to generate the mesh) can be used by the light estimation engine 210 to determine a light intensity associated with planes of the mesh or polygons of the mesh. For example, the light estimation engine 210 can use various ray tracing techniques to generate a data structure (e.g., a light score map) indicating light intensity, light source, light direction, angles, etc. of light in represented in the mesh. In some examples, the 3D scene optimization engine 204 can generate the data structure (e.g., the light score map) mapping lighting information to various planes or polygons represented in the mesh.

In some examples, the mesh generator can generate user attention data associated with user location, head tracking, gaze tracking, etc. to generate attention scores. An attention score can be a value representing an amount of time or frequency of a user interacting with objects or locations represented in the mesh. In some examples, the 3D scene optimization engine 204 can generate the attention scores based on the user movement data and other data associated with user interactions with the environment.

The mesh generator 202 can provide meshes of various resolutions, user movement data, and the data structure associated with lighting in the environment to the 3D scene optimization engine 204. In some examples, the mesh generator 202 can provide updated meshes to the 3D scene optimization engine 204 periodically or based on changes to the environment. For example, when an object in the environment is moved, the mesh generator 202 can update the meshes or generate additional meshes including the changes to the mesh.

The 3D scene optimization engine 204 can process meshes to determine insights of the meshes. Insights of the meshes can include relationships between characteristics of the meshes and data associated with user interactions with the environment represented in the mesh. For example, insights can include regions of the environment, landmarks represented in the mesh, lighting of the environment, etc. The insights can be applied as labels to a data structure mapping insights to various polygons of the mesh, or plurality of polygons, to provide context to the polygons of the mesh.

In one example of a mesh insight, the 3D scene optimization engine 204 can process meshes to determine regions of the mesh. For example, the 3D scene optimization engine 204 can partition the mesh into regions based on how the polygons of the mesh connect. In such an example, the 3D scene optimization engine can determine, based on the connection of the polygons of a mesh, a wall represented in the mesh. The 3D scene optimization engine 204 can determine the portion of the mesh including the wall is a separate region from a region on the other side of the wall (e.g., to distinguish between two separate rooms). The 3D scene optimization engine 204 can generate a tag or label associated with the region of the mesh and apply the tag or label to a data structure mapping the tags or labels to the polygons within the region. For example, the data structure can be key-value pairs mapping polygons to insights of the mesh such as the region, landmarks, locations, etc.

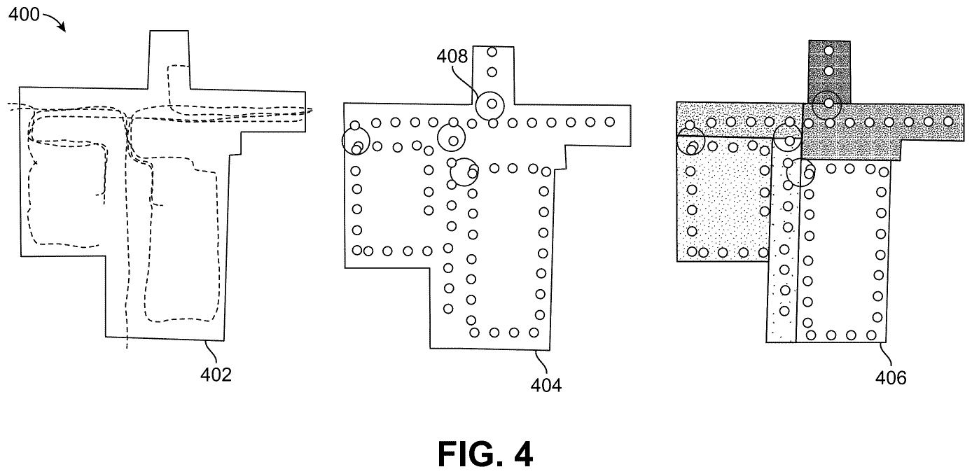

In another example of a mesh insight, the 3D scene optimization engine 204 can process meshes and information associated with the user and environment (e.g., the user movement data) to determine landmarks represented in the meshes. Landmarks can include objects or locations represented in the mesh which are determined as likely or regularly to be viewed or accessed by users. For example, the 3D scene optimization engine 204 can determine landmarks based on movement of users through the environment represented in the mesh. Further description of landmark detection is provided in the description of FIG. 4.

In another example of a mesh insight, the 3D scene optimization engine 204 can predict user trajectory (e.g., a prediction of where within the environment the user is traveling to) when the user moves through the environment. In such an example, the 3D scene optimization engine 204 can determine, based on additional mesh insights such as landmarks and regions of the environment and the user movement data from the mesh generator 202, a predicted trajectory of the user. For example, the 3D scene optimization engine 204 can predict user trajectory based on whether a user is moving towards a landmark and objects (e.g., obstacles) between the user and the landmark. In further examples, the predicted user trajectory can include trajectories based on where regions of the environment connect (e.g., doorways between rooms, stairways between floors, etc.).

In some aspects, the 3D scene optimization engine 204 can generate a weighted score associated with lighting information and attention scores from the mesh generator 202. In such an example, the 3D scene optimization engine 204 can generate a data structure to map the weighted scores to meshes of varying resolutions and levels of detail. In some examples, the 3D scene optimization engine 204 can use the weighted score to adjust meshes (e.g., to refine the meshes). In such an example, the 3D scene optimization engine can use the weighted score to blend meshes of different resolutions such that the parts of the mesh which user are predicted to view or interact with are of a higher resolution than parts of the mesh not viewed by the user.

The 3D scene optimization engine 204 can further blend mesh representations of the environment based on determined insights, mesh parameters of the applications to receive the blended mesh representations, and user movement in the environment (e.g., user location, user field of view, predicted user trajectory, etc.). For example, the 3D scene optimization engine 204 can blend a first mesh (e.g., a high resolution mesh) with a second mesh (e.g., low resolution mesh) where the portions of the blended mesh which are of the high resolution mesh are the portions of the mesh viewable to the user or predicted to be viewed by the user (e.g., predicted based on predicted trajectory, landmarks, etc.). For example, the 3D scene optimization engine 204 can generate a blended mesh with a higher resolution within the field of view of the user and lower resolution in regions not viewable at the user position or orientation.

In some examples, the 3D scene optimization engine 204 can pre-cache (e.g., store in memory) a blended mesh to be transmitted to the applications or services (e.g., the applications or services executed on a client device) based on a predicted movement of the user (e.g., the predicted trajectory of the user). By having the blended mesh representation pre-cached to be transmitted, the 3D scene optimization engine 204 can reduce latency between the 3D scene optimization engine 204 and the client devices 206 by being prepared to transmit the blended mesh before requested by the client devices 206 (e.g., the applications executed using the client devices 206) or before mesh parameters (e.g., mesh parameters set by the applications of the client devices 206) trigger transmission of the blended mesh.

In some examples, the 3D scene optimization engine 204 can generate blended meshes using the weighted scores (e.g., the data structure representing weighted scores of the attention score and the light map score). For example, the 3D scene optimization engine 204 can apply the weighted scores to planes within the field of view of the user (e.g., within a frustum representing the field of view of the user) to adjust the resolution of the blended map within the field of view of the user (e.g., to increase resolution for parts of the blended mesh with higher weighted scores).

The 3D scene optimization engine 204 can generate blended meshes based on mesh parameters (e.g., policies) of the applications and services executed on the client devices 206. For example, different applications can have different mesh parameters based on requirements of the applications. In such an example, the mesh parameters can include an update frequency parameter and a quality parameter (e.g., resolution and level of detail parameter). For example, an application for a virtually touring an environment represented in the mesh may use a higher resolution mesh than an application for simulating spatial audio of the environment.

The update frequency parameter can represent how often or when the 3D scene optimization engine 204 should transmit an updated blended mesh (e.g., periodically, based on movement of the user, or based on changes in the environment, etc.). For example, the update frequency parameter can indicate the 3D scene optimization engine should transmit an updated mesh based on changes in lighting, user movement, changes in user field of view (e.g., movement of the frustum view associated with movements of the user), etc. In some examples, multiple applications or services can run on the client devices 206 concurrently and concurrently request blended meshes of different resolutions.

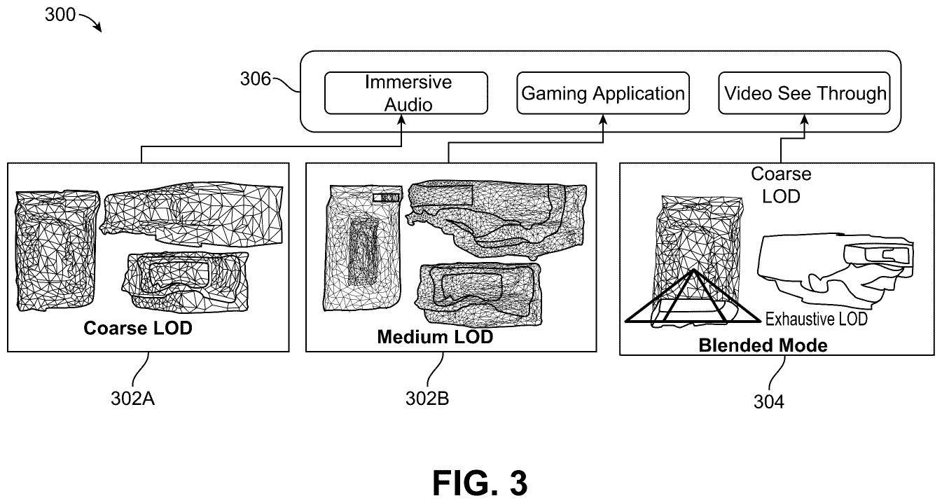

FIG. 3 is a block diagram illustrating example mesh representations of an environment provided by a 3D scene optimization engine (e.g., the 3D scene optimization engine 204 of FIG. 2) to various applications of client device 306 (e.g., a client device of the client devices 206 of FIG. 2). FIG. 3 illustrates that different applications of the client device 306 can include different mesh parameters regarding resolution (e.g., level of detail (LOD)). For example, an immersive audio application for simulating spatial audio may use different resolution meshes (e.g., mesh 302A) than a gaming application (e.g., mesh 302B). Other applications, such as a video see-through application may use a blended mesh 304 to have higher resolution in areas within field of view of the user than other areas not within field of view of the user. In some examples, the various applications of the client device 306 can operate concurrently. For example, the immersive audio application, gaming application, and the immersive see through application can operate concurrently to provide an AR gaming experience with spatial audio.

FIG. 4 is a block illustrating an example determining landmarks represented in a mesh. For example, a 3D scene optimization engine (e.g., the 3D scene optimization engine 204 of FIG. 2) can process meshes and user movement data to determine landmarks in an environment. For example, mesh 402 is an aerial view representation of user movement through the environment represented by the mesh 402. Mesh 404 illustrates example overlaps 408 in paths traversed by a user through the environment. In some examples, the 3D scene optimization engine can determine landmarks based on intersections in paths traversed by the user. For example, the intersections can indicate landmarks such as a doorway connecting regions of an environment (e.g., different rooms in an environment). In such an example, the location of the overlaps 408 can be determined to include landmarks. In further examples, user movement data can indicate an amount of time a user is at a location or looking at an object. In such an example, the 3D scene optimization engine can determine a location includes a landmark based on the amount of time a user is at the location or the amount of time (or frequency) the user looks at areas in the environment.

The 3D scene optimization engine can generate a tag or label associated with the polygons (or regions) of the mesh indicating a landmark. The 3D scene optimization engine can apply the tag or label to a data structure (e.g., by updating the data structure) mapping insights with polygons or regions of the mesh.

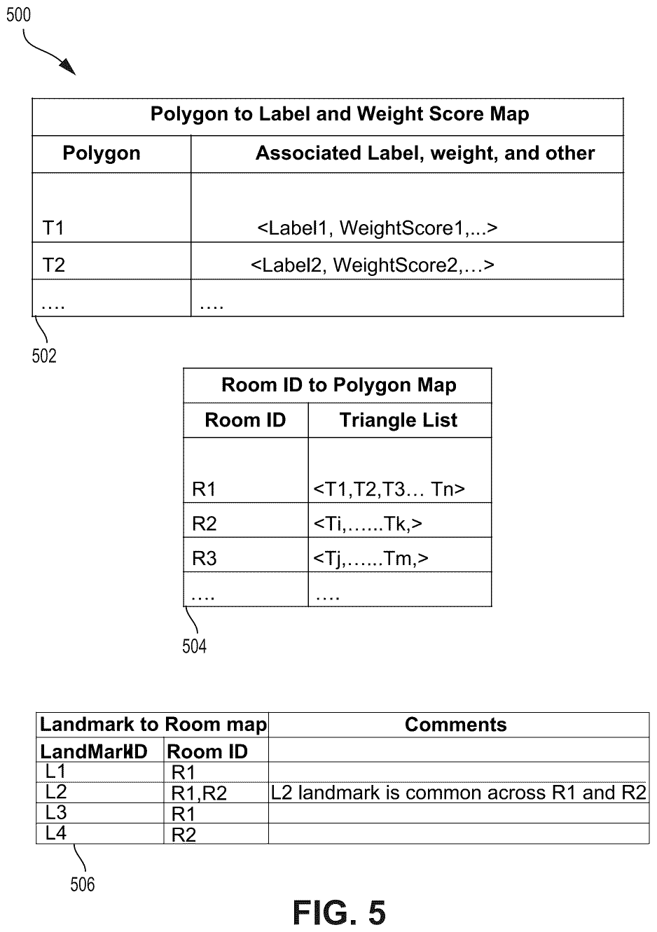

FIG. 5 is a block diagram illustrating example data structures 500 mapping insights of the mesh with regions or polygons of the mesh. For example, insight 502 is a data structure mapping weight scores (e.g., weighted value representation of attention scores and lighting information) to individual polygons of the mesh. For example, the weight scores can indicate an amount of time and frequency at which a user interacted with individual polygons (e.g., how long individual polygons were within field of view of the user). The weighted score also can indicate lighting information associated with polygons, such as light intensity, light reflections, etc. A 3D scene optimization engine (e.g., the 3D scene optimization engine 204 of FIG. 2) can adjust the resolution of blended meshes based on the weighted scores, such as by determining to use higher resolution meshes for areas of the mesh having higher weighted scores.

Insight 504 is a data structure mapping regions of the environment to polygons of the mesh. For example, the 3D scene optimization engine can determine different regions of the mesh, such as by partitioning the mesh into rooms. Insight 504 is a data structure indicating the various polygons of the mesh associated with the various rooms. Insight 506 is a data structure mapping landmarks of the environment to regions of the environment (e.g., rooms). For example, the data structure can indicate which region of the environment a landmark is located.

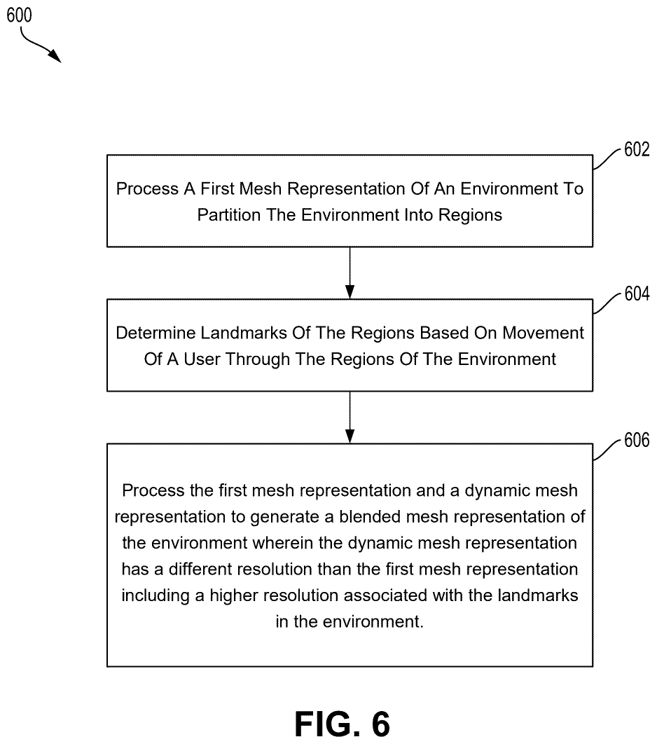

FIG. 6 is a flow diagram illustrating an example process 600 for adjusting mesh representations. In particular, the process 600 illustrates an example process of adjusting mesh representations based on mesh insights including landmarks and regions of the mesh. For example, the process 600 can be performed using the XR system 100 of FIG. 1, a server, edge device, the 3D scene optimization engine 204 of FIG. 2, the computing device or computing system 700 of FIG. 7, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 600 can be implemented as software components that are executed and run on one or more processors (e.g., the compute components 114 of FIG. 1, the processor 710 of FIG. 7, or other processor(s)) of the computing device.

At block 602, the computing device (or component thereof) can process a first mesh representation of an environment to partition the environment into regions. For example, the mesh representation can be the interior of a building. In such an example, the regions can be rooms of the building or hallways. In some examples, the first mesh representation can be a 3D polygonal representation of the environment. For example, the first mesh can be a 3D representation of the environment using polygons (e.g., face, vertices, and edges of a plurality of polygons arranged in a 3D space). In such an example, the polygons can include additional information associated with the environment, such as color, light intensity, textures, and various visual characteristics of the environment. In another example, the polygons can include a weighted score associated with a light intensity of a plane associated with the polygons (e.g., the plurality of polygons) and an amount of time of user interaction with the polygons.

In some examples, the first mesh representation can be generated using an additional device. For example, the first mesh representation can be generated using an XR device of a user and transmitted to the computing device. In such an example, the additional device can be a different device from the computing device. In further examples, the additional device can be the computing device. For example, the computing device can receive the first mesh representation from the server, or a database of meshes. In another example, the computing device can receive multiple mesh representations of the environment. In such an example, the computing device can receive mesh representations of different resolutions from the server. In another example, the computing device can receive a dynamic mesh representation of the environment. In such an example, the dynamic mesh representation can be a mesh representation adjustable based on user interactions with an environment or changes in the environment. For example, the dynamic mesh representation can adjust based on one or more of a user location, lighting conditions of the environment, or a user viewpoint.

At block 604, the computing device (or component thereof) can determine landmarks of the regions based on movement of a user through the regions of the environment. For example, landmarks can include traversable intersections of the regions of the environment. In one such example, a landmark can include a doorway. For example, the doorway can represent an intersection between rooms which users can traverse to travel between the rooms. In some examples, the landmarks can represent areas of the environment which users are more likely to be located or to travel. In continuing the example of a doorway, a doorway can be considered a landmark, at least because to enter a room (e.g., a room with one doorway), a user must pass through the same location to enter the room. Doorways are generally one of the more traversed locations in a building because users must pass through them before users can travel to a location in the room. Landmarks can include other locations within a region of the environment (e.g., within a room). For example, the computing device can determine landmarks of the regions based on an amount of time the user is positioned at one or more locations within the regions.

At block 606, the computing device (or component thereof) can process the first mesh representation and a dynamic mesh representation to generate a blended mesh representation of the environment. In such an example, the dynamic mesh representation can have a different resolution than the first mesh representation. For example, the dynamic mesh representation can include a higher resolution associated with the landmarks in the environment. In some examples, a resolution of the blended mesh representation can be based on a resolution parameter of an application of a first device configured to receive the blended mesh representation. For example, the computing device can transmit blended mesh representation to a first device. In further examples, the computing device (or component thereof) can transmit the blended mesh representation based on an update frequency policy set by an application. In further examples, the first device can be a client device. The first device can communicate with a server to transmit mesh representations (e.g., the first mesh representation, the dynamic mesh representation, the blended mesh representation, etc.). In such an example, additional devices can download the mesh representations from the server.

In some examples, the computing device (or component thereof) can generate a predicted trajectory of the user based on additional movement of the user within the environment. In further examples, the computing device (or component thereof) can adjust a resolution of the blended mesh representation along the predicted trajectory of the user. For example, the computing device can adjust the resolution of the blended mesh representation to be higher along the predicted trajectory of the user and adjust the resolution of the blended mesh representation to be lower outside of the predicted trajectory. In such examples, the predicted trajectory can be based on a direction of additional movement of a user and locations of the landmarks in the environment. In further examples, the computing device (or component thereof) can store, based on the predicted trajectory, a portion of the blended mesh representation in memory of the computing device to be transmitted to a first device.

In further examples, the mesh representations (e.g., the first mesh representation, the second mesh representation, the blended mesh representation, etc.) can include a plurality of polygons (e.g., faces, edges, vertices of polygons) representing the environment. The plurality of polygons can include a weighted score associated with characteristics of the environment and objects in the environment represented by the plurality of polygons. For example, the plurality of polygons can include a weighted score associated with a light intensity of a plane associated with the plurality of plurality of polygons. In such an example, the weighted score can be associated with the direction and intensity of light in the environment. Further characteristics can include color, texture, and other visual characteristics. In some examples, the weighted score can also include a score associated with an importance of a plurality of polygons representing an object or the environment. For example, the importance can be based on an amount of time a user interacts (e.g., user interaction) with the plurality of polygons. In such an example, an increase in the amount of time interacting with the plurality of polygons or an object represented by the plurality of polygons (e.g., gazing at an object, touching an object, etc.) can indicate an increased importance of the plurality of polygons. The computing device (or component thereof) can adjust the blended mesh representation based on the weighted score, such as by increasing or decreasing resolutions of portions of the blended mesh representation based on the weighted score.

FIG. 7 is a diagram illustrating an example of a system for implementing certain aspects of the present technology. In particular, FIG. 7 illustrates an example of computing system 700, which may be for example any computing device making up internal computing system, a remote computing system, a camera, or any component thereof in which the components of the system are in communication with each other using connection 705. Connection 705 may be a physical connection using a bus, or a direct connection into processor 710, such as in a chipset architecture. Connection 705 may also be a virtual connection, networked connection, or logical connection.

In some aspects, computing system 700 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 700 includes at least one processing unit (CPU or processor) 710 and connection 705 that communicatively couples various system components including system memory 715, such as read-only memory (ROM) 720 and random access memory (RAM) 725 to processor 710. Computing system 700 may include a cache 712 of high-speed memory connected directly with, in close proximity to, or integrated as part of processor 710.

Processor 710 may include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms. In some instances, multimodal systems may enable a user to provide multiple types of input/output to communicate with the computing system 700.

Computing system 700 may include communications interface 740, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 730 may include software services, servers, services, etc., that when the code that defines such software is executed by the processor 710, it causes the system to perform a function. In some aspects, a hardware service that performs a particular function may include the software component stored in a computer-readable medium in connection with the necessary hardware components, such as processor 710, connection 705, output device 735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for mesh representation adjustment, the apparatus comprising: at least one memory; and at least one processor coupled to the at least one memory and configured to: process a first mesh representation of an environment to partition the environment into regions; determine landmarks of the regions based on movement of a user through the regions of the environment; and process the first mesh representation and a dynamic mesh representation to generate a blended mesh representation of the environment wherein the dynamic mesh representation has a different resolution than the first mesh representation including a higher resolution associated with the landmarks in the environment.
Aspect 2. The apparatus of Aspect 1, wherein the dynamic mesh representation is adjustable based on at least one of a user location, lighting conditions of the environment, or a user viewpoint.
Aspect 3. The apparatus of any of Aspects 1 to 2, wherein a resolution of the blended mesh representation is based on resolution parameter of an application of a first device configured to receive the blended mesh representation, and wherein the at least one processor is configured to: transmit the blended mesh representation.
Aspect 4. The apparatus of any of Aspects 1 to 3, wherein the at least one processor is configured to transmit the blended mesh representation based on an update frequency policy set by the application.
Aspect 5. The apparatus of any of Aspects 1 to 4, wherein the first device is a client device, and the apparatus is a server.
Aspect 6. The apparatus of any of Aspects 1 to 5, wherein the at least one processor is configured to: generate a predicted trajectory of the user based on additional movement of the user within the environment; adjust a resolution of the blended mesh representation along the predicted trajectory of the user; and store, based on the predicted trajectory, a portion of the blended mesh representation in the at least one memory of the apparatus to be transmitted to a first device.
Aspect 7. The apparatus of any of Aspects 1 to 6, wherein the predicted trajectory is based on a direction of the additional movement and locations of the landmarks.
Aspect 8. The apparatus of any of Aspects 1 to 7, wherein the landmarks include traversable intersections of the regions of the environment.
Aspect 9. The apparatus of any of Aspects 1 to 8, wherein the at least one processor is configured to: determine the landmarks of the regions based an amount of time the user is positioned at one or more locations within the regions.
Aspect 10. The apparatus of any of Aspects 1 to 9, wherein the first mesh representation includes a plurality of polygons, wherein the plurality of polygons includes a weighted score associated with a light intensity of a plane associated with the plurality of polygons and an amount of time of user interaction with the plurality of polygons, and wherein the at least one processor is configured to: adjust the blended mesh representation based on the weighted score.
Aspect 11. A method comprising: processing a first mesh representation of an environment to partition the environment into regions; determining landmarks of the regions based on movement of a user through the regions of the environment; and processing the first mesh representation and a dynamic mesh representation to generate a blended mesh representation of the environment wherein the dynamic mesh representation has a different resolution than the first mesh representation including a higher resolution associated with the landmarks in the environment.
Aspect 12. The method of Aspect 11, wherein the dynamic mesh representation is adjustable based on at least one of a user location, lighting conditions of the environment, or a user viewpoint.
Aspect 13. The method of any of Aspects 11 to 12, further comprising: transmitting the blended mesh representation; wherein a resolution of the blended mesh representation is based on resolution parameter of an application of a first device configured to receive the blended mesh representation.
Aspect 14. The method of any of Aspects 11 to 13, further comprising: transmitting the blended mesh representation based on an update frequency policy set by the application.
Aspect 15. The method of any of Aspects 11 to 14, wherein the first device is a client device.
Aspect 16. The method of any of Aspects 11 to 15, further comprising: generating a predicted trajectory of the user based on additional movement of the user within the environment; adjusting a resolution of the blended mesh representation along the predicted trajectory of the user; and storing, based on the predicted trajectory, a portion of the blended mesh representation in memory of an apparatus to be transmitted to a first device.
Aspect 17. The method of any of Aspects 11 to 16, wherein the predicted trajectory is based on a direction of the additional movement and locations of the landmarks.
Aspect 18. The method of any of Aspects 11 to 17, wherein the landmarks include traversable intersections of the regions of the environment.
Aspect 19. The method of any of Aspects 11 to 18, further comprising: determining the landmarks of the regions based an amount of time the user is positioned at one or more locations within the regions.
Aspect 20. The method of any of Aspects 11 to 19, wherein the first mesh representation includes a plurality of polygons, wherein the plurality of polygons includes a weighted score associated with a light intensity of a plane associated with the plurality of polygons and an amount of time of user interaction with the plurality of polygons, and wherein the method further comprises: adjusting the blended mesh representation based on the weighted score.
Aspect 21. A non-transitory computer-readable medium having stored thereon instructions that, when executed by at least one processor, cause the at least one processor to perform one or more of operations according to any of Aspects 11 to 20.
Aspect 22. An apparatus for, the apparatus for mesh representation adjustment comprising one or more means for performing operations according to any of Aspects 11 to 20.

What is claimed is:

1. An apparatus for mesh representation adjustment, the apparatus comprising:
at least one memory; and
at least one processor coupled to the at least one memory and configured to:
process a first mesh representation of an environment to partition the environment into regions;
determine landmarks of the regions based on movement of a user through the regions of the environment; and
process the first mesh representation and a dynamic mesh representation to generate a blended mesh representation of the environment wherein the dynamic mesh representation has a different resolution than the first mesh representation including a higher resolution associated with the landmarks in the environment.

2. The apparatus of claim 1, wherein the dynamic mesh representation is adjustable based on at least one of a user location, lighting conditions of the environment, or a user viewpoint.

3. The apparatus of claim 1, wherein a resolution of the blended mesh representation is based on resolution parameter of an application of a first device configured to receive the blended mesh representation, and wherein the at least one processor is configured to:
transmit the blended mesh representation.

4. The apparatus of claim 3, wherein the at least one processor is configured to transmit the blended mesh representation based on an update frequency policy set by the application.

5. The apparatus of claim 4, wherein the first device is a client device, and the apparatus is a server.

6. The apparatus of claim 1, wherein the at least one processor is configured to:
generate a predicted trajectory of the user based on additional movement of the user within the environment;
adjust a resolution of the blended mesh representation along the predicted trajectory of the user; and
store, based on the predicted trajectory, a portion of the blended mesh representation in the at least one memory of the apparatus to be transmitted to a first device.

7. The apparatus of claim 6, wherein the predicted trajectory is based on a direction of the additional movement and locations of the landmarks.

8. The apparatus of claim 1, wherein the landmarks include traversable intersections of the regions of the environment.

9. The apparatus of claim 1, wherein the at least one processor is configured to:
determine the landmarks of the regions based an amount of time the user is positioned at one or more locations within the regions.

10. The apparatus of claim 1, wherein the first mesh representation includes a plurality of polygons, wherein the plurality of polygons includes a weighted score associated with a light intensity of a plane associated with the plurality of polygons and an amount of time of user interaction with the plurality of polygons, and wherein the at least one processor is configured to:
adjust the blended mesh representation based on the weighted score.

11. A method comprising:
processing a first mesh representation of an environment to partition the environment into regions;
determining landmarks of the regions based on movement of a user through the regions of the environment; and
processing the first mesh representation and a dynamic mesh representation to generate a blended mesh representation of the environment wherein the dynamic mesh representation has a different resolution than the first mesh representation including a higher resolution associated with the landmarks in the environment.

12. The method of claim 11, wherein the dynamic mesh representation is adjustable based on at least one of a user location, lighting conditions of the environment, or a user viewpoint.

13. The method of claim 11, further comprising:
transmitting the blended mesh representation;
wherein a resolution of the blended mesh representation is based on resolution parameter of an application of a first device configured to receive the blended mesh representation.

14. The method of claim 13, further comprising:
transmitting the blended mesh representation based on an update frequency policy set by the application.

15. The method of claim 14, wherein the first device is a client device.

16. The method of claim 11, further comprising:
generating a predicted trajectory of the user based on additional movement of the user within the environment;
adjusting a resolution of the blended mesh representation along the predicted trajectory of the user; and
storing, based on the predicted trajectory, a portion of the blended mesh representation in memory of an apparatus to be transmitted to a first device.

17. The method of claim 16, wherein the predicted trajectory is based on a direction of the additional movement and locations of the landmarks.

18. The method of claim 11, wherein the landmarks include traversable intersections of the regions of the environment.

19. The method of claim 11, further comprising:
determining the landmarks of the regions based an amount of time the user is positioned at one or more locations within the regions.

20. A non-transitory computer-readable medium having stored thereon instructions that, when executed by at least one processor, cause the at least one processor to:
process a first mesh representation of an environment to partition the environment into regions;
determine landmarks of the regions based on movement of a user through the regions of the environment; and
process the first mesh representation and a dynamic mesh representation to generate a blended mesh representation of the environment wherein the dynamic mesh representation has a different resolution than the first mesh representation including a higher resolution associated with the landmarks in the environment.
